(19) United States
(12) Patent Application Publication
(10) Pub. No.: US 2019/0351913 A1
(43) Pub. Date: Nov. 21, 2019

(54) SENSOR SYSTEM AND METHOD FOR INSPECTING THE SAME

(71) Applicant: Koito Manufacturing Co., Ltd., Tokyo (JP)

(72) Inventors: Shigeyuki Watanabe, Shizuoka-shi (Shizuoka) (JP); Yuichi Watano, Shizuoka-shi (Shizuoka) (JP)

(21) Appl. No.: 16/408,589

(22) Filed: May 10, 2019

(30) Foreign Application Priority Data
May 18, 2018 (JP) 2018-096092

(51) Int. Cl. B60W 50/02; B60R 11/04

(52) U.S. Cl. CPC B60W 50/0205; B60W 2050/021; B60W 2050/0215; B60R 11/04

(57) ABSTRACT

A sensor system mounted on a vehicle includes: a first sensor configured to detect information on a first area outside the vehicle; a second sensor configured to detect information on a second area that partially overlaps with the first area outside the vehicle; a memory configured to store a positional relationship between the first sensor and the second sensor based on information detected in an overlapped area between the first area and the second area; and a processor configured to generate positional displacement information of the sensor system with respect to the vehicle, based on the information detected by at least one of the first sensor and the second sensor and the positional relationship.

### CROSS-REFERENCE TO RELATED APPLICATIONS

This application is based on and claims priority from Japanese Patent Application No. 2018-096092, filed on May 18, 2018, with the Japan Patent Office, the disclosure of which is incorporated herein in its entirety by reference.

### TECHNICAL FIELD

The present disclosure relates to a sensor system mounted on a vehicle, and a method for inspecting the sensor system.

### BACKGROUND

In order to implement an automatic driving technique for a vehicle, it is necessary to mount a sensor on the vehicle body for acquiring information outside the vehicle. Different types of sensors may be used so as to acquire information on the outside more accurately. Examples of such sensors may include a camera or a LiDAR (light detection and ranging) sensor (see, e.g., Japanese Patent Laid-Open Publication No. 2010-185769).

### SUMMARY

When the sensor as described above is mounted on the vehicle body, it is necessary to adjust a posture or a position of the sensor with respect to the vehicle body. As the number of sensor increases, the burden of adjusting operation is increased because the number of objects that require adjustment increases.

The present disclosure is to alleviate the burden of operation that adjusts the posture or a position of the plurality of sensors mounted on a vehicle.

An aspect for achieving the object is a sensor system mounted on a vehicle, including: a first sensor configured to detect information on a first area outside the vehicle; a second sensor configured to detect information on a second area that partially overlaps with the first area outside the vehicle; a memory configured to store a positional relationship between the first sensor and the second sensor based on information detected in an overlapped area between the first area and the second area; and a processor configured to generate positional displacement information of the sensor system with respect to the vehicle, based on the information detected by at least one of the first sensor and the second sensor and the positional relationship.

An aspect for achieving the object is a method for inspecting a sensor system mounted on a vehicle, the method including: disposing a first target in an area where a first area in which a first sensor detects information and a second area in which a second sensor detects information overlap with each other; determining a reference position of the first sensor based on a detection result of the first target by the first sensor; determining a positional relationship between the first sensor and the second sensor based on a detection result of the first target by the second sensor and the reference position; detecting a second target by at least one of the first sensor and the second sensor in a state where the sensor system is mounted on the vehicle; and detecting positional displacement of the sensor system with respect to the vehicle, based on a detection result of the second target and the positional relationship.

According to the sensor system and the inspecting method configured as described above, when the second target is disposed in at least one of the first area and the second area, the displacement amount of the entire sensor system with respect to the vehicle may be specified by detecting the displacement amount from the reference position of either the first sensor unit or the second sensor unit. That is, the degree of freedom of disposition of the second target is increased, and it is unnecessary to perform adjustment through detecting the second target for each sensor unit. Therefore, it is possible to alleviate the burden of operation that adjusts the postures or the positions of the plurality of sensors mounted on the vehicle.

The sensor system described above may be configured as follows. The sensor system further includes a third sensor configured to detect information on a third area that partially overlaps with the first area outside the vehicle, in which the memory stores a positional relationship between the first sensor and the third sensor based on information detected in an overlapped area between the first area and the second area, and the processor generates positional displacement information of the sensor system with respect to the vehicle, based on the information detected by at least one of the first sensor, the second sensor, and the third sensor, and the positional relationship.

In this case, when the second target is disposed in at least one of the first area, the second area, and the third area, the displacement amount of the entire sensor system with respect to the vehicle may be specified by detecting the displacement amount from the reference position of one of the first sensor, the second sensor, and the third sensor. That is, the degree of freedom of disposition of the second target is increased, and it is unnecessary to perform adjustment through detecting the second target for each sensor unit. Therefore, it is possible to alleviate the burden of operation that adjusts the postures or the positions of the plurality of sensors mounted on the vehicle.

In the present specification, the “sensor unit” refers to a constituent unit of a component that has a required information detection function and is able to be distributed as a single unit.

In the present specification, “driving support” refers to a control process that at least partially performs at least one of driving operations (steering wheel operation, acceleration, and deceleration), monitoring of the running environment, and backup of the driving operations. That is, the driving support includes the meaning from a partial driving support such as collision damage mitigation brake function and lane-keep assist function to a full automatic driving operation.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a view illustrating a configuration of a sensor system according to an embodiment.

FIG. 2 is a view illustrating a position of the sensor system of FIG. 1 in a vehicle.

FIG. 3 is a flow chart illustrating a method for inspecting the sensor system of FIG. 1.

### DETAILED DESCRIPTION

In the following detailed description, reference is made to the accompanying drawings, which form a part hereof. The illustrative embodiments described in the detailed description, drawing, and claims are not meant to be limiting. Other embodiments may be utilized, and other changes may be made, without departing from the spirit or scope of the subject matter presented here.

Hereinafter, an embodiment according to the present disclosure will be described in detail with reference to accompanying drawings. In the respective drawings used in the following description, a scale is suitably changed in order to have a recognizable size of each element.

An arrow F indicates a front side direction of the illustrated structure in the accompanying drawings. An arrow B indicates a back side direction of the illustrated structure. An arrow L indicates a left side direction of the illustrated structure. An arrow R indicates a right side direction of the illustrated structure. Also, “left side” and “right side” used in the following description indicate left and right directions viewed from the driver's seat.

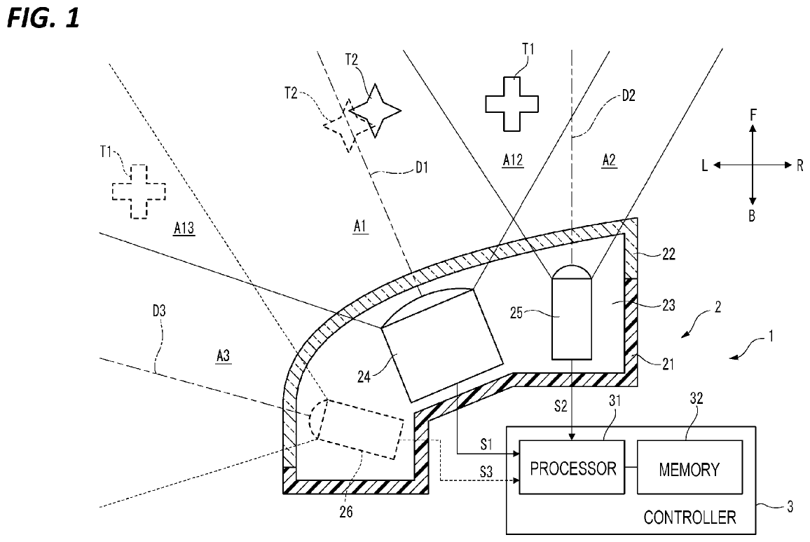

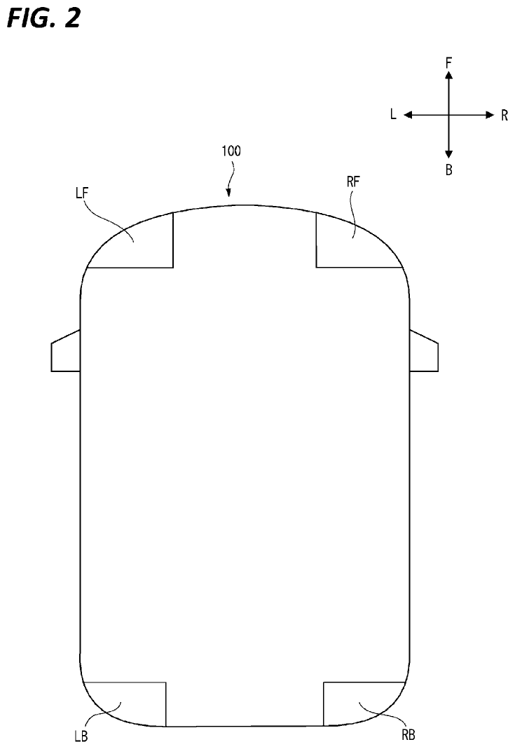

As illustrated in FIG. 1, a sensor system 1 according to an embodiment includes a sensor module 2. The sensor module 2 is mounted on, for example, a left-front side corner portion LF of a vehicle 100 illustrated in FIG. 2.

The sensor module 2 includes a housing 21 and a translucent cover 22. The housing 21 defines an accommodating chamber 23 together with the translucent cover 22.

The sensor module 2 includes a LiDAR sensor unit 24 and a front side camera unit 25. The LiDAR sensor unit 24 and the front side camera unit 25 are disposed in the accommodating chamber 23.

The LiDAR sensor unit 24 has a configuration for emitting invisible light toward a detection area A1 outside the vehicle 100, and a configuration for detecting returned light resulted from reflection of the invisible light by an object present in the detection area A1. The LiDAR sensor unit 24 may include a scanning mechanism that changes the emission direction (that is, detection direction) and sweeps the invisible light as necessary. For example, infrared light having a wavelength of 905 nm may be used as invisible light.

The LiDAR sensor unit 24 may acquire a distance to the object related to the returned light, based on, for example, a time taken from a timing at which the invisible light is emitted in a certain direction until the returned light is detected. Further, information on the shape of the object related to the returned light may be acquired by accumulating such distance data in association with the detection position. In addition to or in place of this, information on properties such as a material of the object related to the returned light may be acquired, based on the difference between the wavelengths of the emitted light and the returned light.

That is, the LiDAR sensor unit 24 is a device that detects information on the detection area A1 outside the vehicle 100. The LiDAR sensor unit 24 outputs a detection signal S1 that corresponds to the detected information. The LiDAR sensor unit 24 is an example of the first sensor. The detection area A1 is an example of the first area.

The front side camera unit 25 is a device that acquires an image of the detection area A2 outside the vehicle 100. The image may include one of a still image and a moving image. The front side camera unit 25 may include a camera sensitive to visible light, or may include a camera sensitive to infrared light.

That is, the front side camera unit 25 is a device that detects information on the detection area A2 outside the vehicle 100. The front side camera unit 25 outputs a detection signal S2 that corresponds to the acquired image. The front side camera unit 25 is an example of the second sensor. The detection area A2 is an example of the second area.

A part of the detection area A1 of the LiDAR sensor unit 24 and a part of the detection area A2 of the front side camera unit 25 are overlapped as an overlapped detection area A12.

The sensor system 1 includes a controller 3. The controller 3 is mounted on the vehicle 100 at an appropriate position. The detection signal S1 output from the LiDAR sensor unit 24 and the detection signal S2 output from the front side camera unit 25 are input to the controller via an input interface (not illustrated).

The controller 3 includes a processor 31 and a memory 32. Signals and data may be communicated between the processor 31 and the memory 32.

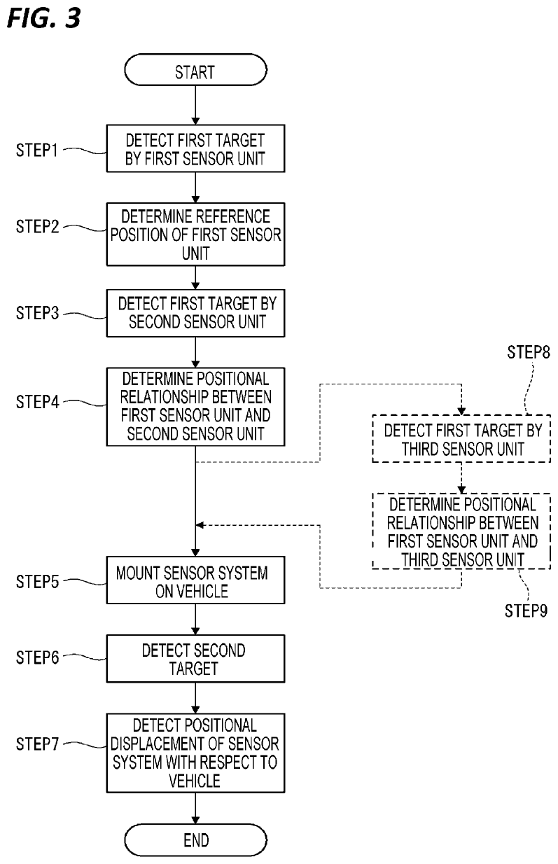

When the sensor system 1 configured as described above is mounted on the vehicle 100, the position of each sensor unit may be displaced from the desired reference position due to the positional displacement of the sensor module 2 with respect to the vehicle body or a tolerance of the vehicle body component. The method for inspecting the sensor system 1 for detecting such a positional displacement will be described with reference to FIGS. 1 and 3.

Detection of a first target T1 by the LiDAR sensor unit 24 is performed (STEP1 in FIG. 3) at a time before the sensor system 1 is mounted on the vehicle 100. As illustrated in FIG. 1, the first target T1 is disposed in the overlapped detection area A12 where the detection area A1 of the LiDAR sensor unit 24 and the detection area A2 of the front side camera unit 25 are overlapped.

Subsequently, the reference position of the LiDAR sensor unit 24 is determined (STEP2 in FIG. 3), based on the detection result of the first target T1 by the LiDAR sensor unit 24. Specifically, at least one of the position and the posture of the LiDAR sensor unit 24 is adjusted by using an aiming mechanism (not illustrated), in order that a detection reference direction D1 of the LiDAR sensor unit 24 illustrated in FIG. 1 establishes a predetermined positional relationship with respect to the first target T1.

The processor 31 of the controller 3 recognizes the position of the first target T1 in the detection area A1 at the completion of the adjustment, by acquiring the detection signal S1. The expression “acquiring the detection signal S1” in the present specification refers to a state where the detection signal S1 input to the input interface from the LiDAR sensor unit 24 may be processed as described later via an appropriate circuit configuration.

Subsequently, detection of the first target T1 by the front side camera unit 25 is performed (STEP3 in FIG. 3). A reference position of the front side camera unit 25 is determined, based on the detection result of the first target T1 by the front side camera unit 25. Specifically, at least one of the position and the posture of the front side camera unit 25 is adjusted by using an aiming mechanism (not illustrated), in order that a detection reference direction D2 of the front side camera unit 25 illustrated in FIG. 1 establishes a predetermined positional relationship with respect to the first target T1.

The processor 31 of the controller 3 recognizes the position of the first target T1 in the detection area A2 at the completion of the adjustment, by acquiring the detection signal S2. The expression “acquiring the detection signal S2” in the present specification refers to a state where the detection signal S2 input to the input interface from the front side camera unit 25 may be processed as described later via an appropriate circuit configuration.

From the reference position of the LiDAR sensor unit 24 and the reference position of the front side camera unit 25 determined via the position of the first target T1 in the overlapped detection area A12, the positional relationship between them is determined (STEP4 in FIG. 3). The positional relationship may be determined by a relative position between the LiDAR sensor unit 24 and the front side camera unit 25, or by each of the absolute position coordinates of the LiDAR sensor unit 24 and the front side camera unit 25 in the sensor module 2. The processor 31 stores the positional relationship determined in this manner in the memory 32.

Next, the sensor system 1 is mounted on the vehicle 100 (STEP5 in FIG. 3). At this time, the positional relationship between the LiDAR sensor unit 24 and the front side camera unit 25 based on the information on the first target T1 detected in the overlapped detection area A12 is stored in the memory 32 of the controller 3. Further, the positional relationship between the LiDAR sensor unit 24 and the front side camera unit 25 is fixed.

In general, mounting of the sensor system 1 on the vehicle 100 is performed at a different location from the location where the reference position of each sensor unit described above is determined. Therefore, detection of a second target T2 illustrated in FIG. 1 is performed (STEP6 in FIG. 3) after the sensor system 1 is mounted on the vehicle 100. In the present example, the second target T2 is disposed in the detection area A1 of the LiDAR sensor unit 24. For example, as illustrated in a broken line in FIG. 1, the position of the second target T2 is determined so as to be positioned in the detection reference direction D1 of the LiDAR sensor unit 24 when the sensor system 1 is mounted on the vehicle without positional displacement.

In the case of the example, the detection of the second target T2 is performed by the LiDAR sensor unit 24. Descriptions will be made on a case where the second target T2 is detected at the position illustrated in a solid ling in FIG. 1 as a result. The detected second target T2 is not in the detection reference direction D1 that is supposed to be originally positioned. Therefore, it is understood that the positional displacement of the sensor system 1 with respect to the vehicle 100 is generated.

The processor 31 of the controller 3 specifies a displacement amount from the reference position of the LiDAR sensor unit 24, based on the detected position of the second target T2 in the detection area A1. In other words, the position where the LiDAR sensor unit 24 is supposed to be originally disposed is specified.

Subsequently, the processor 31 specifies the current position of the front side camera unit 25, based on the positional relationship between the LiDAR sensor unit 24 and the front side camera unit 25 stored in the memory 32. In other words, the position where the front side camera unit 25 is supposed to be originally disposed is specified.

The processor 31 generates positional displacement information of the sensor system 1 with respect to the vehicle 100 (STEP7 in FIG. 3). Specifically, the positional displacement information of the sensor system 1 with respect to the vehicle 100 is constituted by the displacement amount from the position where the LiDAR sensor unit 24 is supposed to be originally disposed and the displacement amount from the position where the front side camera unit 25 is supposed to be originally disposed, which are specified in the above-described manner.

The controller 3 may output the positional displacement information. In this case, at least one of the position and the posture of the sensor module 2 may be adjusted mechanically by an operator in order to eliminate the positional displacement of the each sensor unit illustrated by the positional displacement information. Alternatively, a signal correction process such as offsetting the positional displacement illustrated by the positional displacement information may be performed by the controller 3, with respect to the detection signal S1 input from the LiDAR sensor unit 24 and the detection signal S2 input from the front side camera unit 25, based on the positional displacement information.

Alternatively, the second target T2 may be disposed in the detection area A2 of the front side camera unit 25. For example, the position of the second target T2 may be determined so as to be positioned in the detection reference direction D2 of the front side camera unit 25 when the sensor system 1 is mounted on the vehicle without positional displacement.

In this case, the detection of the second target T2 is performed by the front side camera unit 25. It is understood that the positional displacement of the sensor system 1 with respect to the vehicle 100 is generated when the detected second target T2 is not in the detection reference direction D2 supposed to be originally positioned.

The processor 31 of the controller 3 specifies a displacement amount from the reference position of the front side camera unit 25, based on the detected position of the second target T2 in the detection area A2. In other words, the position where the front side camera unit 25 is supposed to be originally disposed is specified.

Subsequently, the processor 31 specifies the current position of the LiDAR sensor unit 24, based on the positional relationship between the LiDAR sensor unit 24 and the front side camera unit 25 stored in the memory 32. In other words, the position where the LiDAR sensor unit 24 is supposed to be originally disposed is specified. As a result, the processor 31 generates the positional displacement information of the sensor system 1 with respect to the vehicle 100 in the same manner as described above.

According to the sensor system 1 and the method for inspecting configured as described above, when the second target T2 is disposed at least one of the detection area A1 and the detection area A2, the displacement amount of the entire sensor system 1 with respect to the vehicle 100 may be specified by detecting the displacement amount from the reference position of either the LiDAR sensor unit 24 or the front side camera unit 25. That is, the degree of freedom of disposition of the second target T2 is increased, and it is unnecessary to perform adjustment through detecting the second target T2 for each sensor unit. Therefore, it is possible to alleviate the burden of operation that adjusts the posture or the position of the plurality of sensors mounted on the vehicle 100.

As illustrated in a broken line in FIG. 1, the sensor module 2 may include a left side camera unit 26. The left side camera unit 26 is disposed in the accommodating chamber 23.

The left side camera unit 26 is a device that acquires an image of the detection area A3 outside the vehicle 100. The image may include one of a still image and a moving image. The left side camera unit 26 may include a camera sensitive to visible light, or may include a camera sensitive to infrared light.

That is, the left side camera unit 26 is a device that detects information on the detection area A3 outside the vehicle 100. The left side camera unit 26 outputs a detection signal S3 that corresponds to the acquired image. The left side camera unit 26 is an example of the third sensor. The detection area A3 is an example of the first area.

A part of the detection area A1 of the LiDAR sensor unit 24 and a part of the detection area A3 of the left side camera unit 26 are overlapped as an overlapped detection area A13.

In this case, detection of the first target T1 by the left side camera unit 26 is performed (STEP8 in FIG. 3) at a time before the sensor system 1 is mounted on the vehicle 100. As illustrated in FIG. 1, the first target T1 is disposed in the overlapped detection area A13 where the detection area A1 of the LiDAR sensor unit 24 and the detection area A3 of the left side camera unit 26 are overlapped.

Subsequently, a reference position of the left side camera unit 26 is determined, based on the detection result of the first target T1 by the left side camera unit 26. Specifically, at least one of the position and the posture of the left side camera unit 26 is adjusted by using an aiming mechanism (not illustrated), in order that a detection reference direction D3 of the left side camera unit 26 illustrated in FIG. 1 establishes a predetermined positional relationship with respect to the first target T1.

The processor 31 of the controller 3 recognizes the position of the first target T1 in the detection area A3 at the completion of the adjustment, by acquiring the detection signal S3. The expression “acquiring the detection signal S3” in the present specification refers to a state where the detection signal S3 input to the input interface from the left side camera unit 26 may be processed as described later via an appropriate circuit configuration.

Meanwhile, the processor 31 of recognizes the position of the first target T1 in the detection area A1 of the LiDAR sensor unit 24 in which the adjustment of the reference position is already completed, by acquiring the detection signal S1.

From the reference position of the left side camera unit 26 determined via the position of the first target T1 in the overlapped detection area A13 and the reference position of the LiDAR sensor unit 24, the positional relationship between them is determined (STEP5 in FIG. 3). The positional relationship may be determined by a relative position between the LiDAR sensor unit 24 and the left side camera unit 26, or by each of the absolute position coordinates of the LiDAR sensor unit 24 and the front side camera unit 26 in the sensor module 2. The processor 31 stores the positional relationship determined in this manner in the memory 32.

Next, the sensor system 1 is mounted on the vehicle 100 (STEP5 in FIG. 3). At this time, the positional relationship between the LiDAR sensor unit 24 and the left side camera unit 26 based on the information on the first target T1 detected in the overlapped detection area A13 is stored in the memory 32 of the controller 3. Further, the positional relationship between the LiDAR sensor unit 24 and the left side camera unit 26 is fixed.

Detection of the second target T2 illustrated in FIG. 1 is performed (STEP6 in FIG. 3) after the sensor system 1 is mounted on the vehicle 100. In the present example, the second target T2 is disposed in the detection area A1 of the LiDAR sensor unit 24. As described above, the processor 31 of the controller 3 specifies a displacement amount from the reference position of the LiDAR sensor unit 24, based on the detected position of the second target T2 in the detection area A1. In other words, the position where the LiDAR sensor unit 24 is supposed to be originally disposed is specified.

At this time, the processor 31 specifies the current position of the left side camera unit 26, based on the positional relationship between the LiDAR sensor unit 24 and the left side camera unit 26 stored in the memory 32, in addition to specifying the current position of the front side camera unit 25. In other words, the position where the left side camera unit 26 is supposed to be originally disposed is specified.

The processor 31 generates positional displacement information of the sensor system 1 with respect to the vehicle 100 (STEP7 in FIG. 3), in order to also include a displacement amount from the position where the left side camera unit 26 is supposed to be originally disposed.

The controller 3 may output the positional displacement information. In this case, at least one of the position and the posture of the sensor module 2 may be adjusted mechanically by an operator in order to eliminate the positional displacement of the each sensor unit illustrated by the positional displacement information. Alternatively, a signal correction process such as offsetting the positional displacement illustrated by the positional displacement information may be performed by the controller 3, with respect to the detection signal S1 input from the LiDAR sensor unit 24, the detection signal S2 input from the front side camera unit 25, and the detection signal S3 input from the left side camera unit 26, based on the positional displacement information.

Alternatively, the second target T2 may be disposed in the detection area A3 of the left side camera unit 26. For example, the position of the second target T2 may be determined so as to be positioned in the detection reference direction D3 of the left side camera unit 26 when the sensor system 1 is mounted on the vehicle without positional displacement.

In this case, the detection of the second target T2 is performed by the left side camera unit 26. It is understood that the positional displacement of the sensor system 1 with respect to the vehicle 100 is generated when the detected second target T2 is not in the detection reference direction D3 supposed to be originally positioned.

The processor 31 of the controller 3 specifies a displacement amount from the reference position of the left side camera unit 26, based on the detected position of the second target T2 in the detection area A3. In other words, the position where the left side camera unit 26 is supposed to be originally disposed is specified.

Subsequently, the processor 31 specifies the current position of the LiDAR sensor unit 24, based on the positional relationship between the LiDAR sensor unit 24 and the left side camera unit 26 stored in the memory 32. In other words, the position where the LiDAR sensor unit 24 is supposed to be originally disposed is specified. The processor 31 also specifies the current position of the front side camera unit 25, based on the positional relationship between the LiDAR sensor unit 24 and the front side camera unit 25 stored in the memory 32. In other words, the position where the front side camera unit 25 is supposed to be originally disposed is also specified. As a result, the processor 31 generates the positional displacement information of the sensor system 1 with respect to the vehicle 100 in the same manner as described above.

According to the sensor system 1 and the method for inspecting configured as described above, when the second target T2 is disposed at least one of the detection area A1, the detection area A2, and the detection area A3, the displacement amount of the entire sensor system 1 with respect to the vehicle 100 may be specified by detecting the displacement amount from the reference position of one of the LiDAR sensor unit 24, the front side camera unit 25, and the left side camera unit 26. That is, the degree of freedom of disposition of the second target T2 is increased, and it is unnecessary to perform adjustment through detecting the second target T2 for each sensor unit. Therefore, it is possible to alleviate the burden of operation that adjusts the posture or the position of the plurality of sensors mounted on the vehicle 100.

The function of the processor 31 in the controller 3 may be implemented by a general-purpose microprocessor operating in cooperation with the memory. Examples of the general-purpose microprocessor may include CPU, MPU, and GPU. The general-purpose microprocessor may include a plurality of process cores. Examples of the memory may include ROM and RAM. A program that executes a process described later may be stored in ROM. The program may include an artificial intelligence program. Examples of the artificial intelligence program may include a learned neural network based on deep learning. The general-purpose microprocessor may designate at least some of the program stored in the ROM and develop it on the RAM, and execute the above process in cooperation with the RAM. Alternatively, the function of the processor 31 described above may be implemented by a dedicated integrated circuit such as a microcontroller, FPGA, and ASIC.

The function of the memory 32 in the controller 3 may be implemented by storage such as a semiconductor memory or a hard disk drive. The memory 32 may be implemented as a part of a memory that operates in cooperation with the processor 31.

The controller 3 may be implemented by, for example, a main ECU that is in charge of a central control process in a vehicle, or by a sub-ECU interposed between the main ECU and each sensor unit.

In the above-described embodiment, the example in which the sensor module 2 includes a LiDAR sensor unit and a camera unit has been described. However, the plurality of sensor units included in the sensor module 2 may be selected to include at least one of a LiDAR sensor unit, a camera unit, a millimeter wave sensor unit, and an ultrasonic wave sensor unit.

The millimeter wave sensor unit includes a configuration for sending a millimeter wave, and a configuration for receiving a reflected wave as a result of reflection of the millimeter wave by an object present outside the vehicle 100. Examples of the millimeter wave frequencies may include, for example, 24 GHz, 26 GHz, 76 GHz, and 79 GHz. The millimeter wave sensor unit may acquire a distance to the object related to the reflected light, based on, for example, time from a timing at which the millimeter wave is sent in a certain direction until the reflected light is received. Further, information on the movement of the object related to the reflected wave may be acquired by accumulating such distance data in association with the detection position.

The ultrasonic wave sensor unit includes a configuration for sending an ultrasonic wave (several tens of kHz to several GHz), and a configuration for receiving a reflected wave as a result of reflection of the ultrasonic wave by an object present outside the vehicle 100. The ultrasonic wave sensor unit may include a scanning mechanism that changes the sending direction (that is, detection direction) and sweeps the ultrasonic wave as necessary.

The ultrasonic wave sensor unit may acquire a distance to the object related to the reflected light, based on, for example, time from a timing at which the ultrasonic wave is sent in a certain direction until the reflected light is received. Further, information on the movement of the object related to the reflected wave may be acquired by accumulating such distance data in association with the detection position.

A sensor module that has a configuration laterally symmetrical to the sensor module 2 illustrated in FIG. 1 may be mounted on a right-front side corner portion RF of the vehicle 100 illustrated in FIG. 2.

The sensor module 2 illustrated in FIG. 1 may be mounted on a left-back side corner portion LB of the vehicle 100 illustrated in FIG. 2. The basic configuration of the sensor module mounted on the left-back side corner portion LB may be vertically symmetrical to the sensor module 2 illustrated in FIG. 1.

The sensor module 2 illustrated in FIG. 1 may be mounted on a right-back side corner portion RB of the vehicle 100 illustrated in FIG. 2. The basic configuration of the sensor module mounted on the right-back side corner portion RB is laterally symmetrical to the sensor module mounted on the left-back side corner portion LB described above.

A lamp unit may be accommodated in the accommodating chamber 23. The “lamp unit” refers to a constituent unit of a component that has a required illumination function and is able to be distributed as a single unit.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A sensor system mounted on a vehicle, comprising:
a first sensor configured to detect information on a first area outside the vehicle;
a second sensor configured to detect information on a second area that partially overlaps with the first area outside the vehicle;
a memory configured to store a positional relationship between the first sensor and the second sensor based on information detected in an overlapped area between the first area and the second area; and
a processor configured to generate positional displacement information of the sensor system with respect to the vehicle, based on the information detected by at least one of the first sensor and the second sensor and the positional relationship.

2. The sensor system according to claim 1, further comprising:
a third sensor configured to detect information on a third area that partially overlaps with the first area outside the vehicle,
wherein the memory stores a positional relationship between the first sensor and the third sensor based on information detected in an overlapped area between the first area and the second area, and
the processor generates positional displacement information of the sensor system with respect to the vehicle, based on the information detected by at least one of the first sensor, the second sensor, and the third sensor, and the positional relationship.

3. A method for inspecting a sensor system mounted on a vehicle, the method comprising:
disposing a first target in an area where a first area in which a first sensor detects information and a second area in which a second sensor detects information overlap with each other;
determining a reference position of the first sensor based on a detection result of the first target by the first sensor;
determining a positional relationship between the first sensor and the second sensor based on a detection result of the first target by the second sensor and the reference position;
detecting a second target by at least one of the first sensor and the second sensor in a state where the sensor system is mounted on the vehicle; and
detecting positional displacement of the sensor system with respect to the vehicle, based on a detection result of the second target and the positional relationship.
